(19) United States
(12) Patent Application Publication
(10) Pub. No.: US 2007/0211001 A1
(43) Pub. Date: Sep. 13, 2007

(54) System and method for laser speckle reduction

(75) Inventor: Walter M. Duncan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/370,336

(22) Filed: Mar. 8, 2006

(51) Int. Cl. G09G 3/34

(52) U.S. Cl. 345/84

(57) ABSTRACT

A system and method for reducing or eliminating speckle when using a coherent light source is provided. A light modulator reflects light emitted by the coherent light source towards a display screen. The light modulator is controlled by selectively applying a bias voltage having a DC component and an AC component to individual pixel elements. The AC component causes physical movement of one or more components of the individual pixel elements by, for example, causing one or more of the components to vibrate or resonate.

### TECHNICAL FIELD

The present invention relates generally to laser systems and, more particularly, to reduction of speckle in projection systems using laser, or other coherent light source, illumination.

### BACKGROUND

Coherent light, such as emitted by a laser, has increasingly been investigated for possible use in a wide variety of applications, including light sources for photography systems, projection systems, medical diagnostic systems, etc. Coherent light, such as light emitted from a laser, generally consists of in-phase waves of light at a single frequency. As a result of this in-phase wave characteristic, coherent light, under many conditions, exhibits a phenomenon commonly referred to as speckle.

Generally, speckle is the appearance of high spatial non-uniformities in the perceived brightness over small areas of a surface that is being irradiated by a coherent light source. Although speckle can arise from uneven illumination of an object such as a surface, its appearance is usually the result of intensity differences caused by interference of the uniform wavefront from the topology of the surface under illumination. Viewing surfaces such as screens may appear to have a smooth surface, but in fact are rough, consisting of ridges and valleys, or may have variations in the index of refraction of the volume. These ridges and valleys or volume variations can cause the coherent light to be reflected, scattered, and transmitted causing interference pattern to form in the reflected, scattered and transmitted light waves, which when viewed appears to have a granular, mottled or speckled pattern. The speckled pattern typically comprises areas of lighter and darker regions caused by the interference. The speckled patterns may be seen by a human eye as well as an optical sensor.

One approach to reduce speckle is to use a rotating diffuser in the coherent source beam. The diffuser acts to redirect portions of the wavefront hence producing rays arriving at the screen surface with a plurality of directions. These diffuser systems, however, have several drawbacks. One such drawback is that the diffuser significantly reduces the light energy. The reduction of light energy results in less illumination of the target and/or less brightness/contrast of a projected image. In the field of projection systems, this drawback is particularly troublesome as the brightness and contrast that may be achieved by a projection system is one of the primary distinguishing factors.

Accordingly, there is a need for a system and method for eliminating or reducing speckle in systems using coherent light. In particular, there is a need for a system and method for eliminating or reducing speckle in projection systems using a coherent light source such as a laser.

### SUMMARY OF THE INVENTION

These and other problems are generally reduced, solved or circumvented, and technical advantages are generally achieved, by embodiments of the present invention, which provides a system and method for speckle reduction in laser or other coherent illumination based systems.

In an embodiment of the present invention, a light projection system utilizing a coherent light source is provided. A light modulator comprises one or more individual pixels and directs light emitted by the coherent light source toward a display surface. The light modulator is controlled by an electronic controller that is configured to apply a bias voltage having a DC component responsible for pixel state changes (i.e., to turn individual pixels on and off) as well as have an AC component. The AC component causes one or more elements of the pixel to vibrate, resonate, or otherwise physically move to modulate the phase and/or amplitude and/or propagation direction of the coherent light arriving at and reflecting/scattering off of the pixel. The AC waveform may be any of a number of waveforms such as sinusoidal, saw tooth, square wave or may be a combination of multiple waveforms and or waveforms of multiple frequencies.

In another embodiment of the present invention, a method of controlling a projection system is provided. The method includes positioning a light modulator to selectively direct light emitted by a coherent light source toward a viewing surface, wherein the light modulator comprises one or more pixels. A bias voltage having a DC component and an AC component is applied to one or more components of the pixels, wherein the AC component causes one or more elements of the pixel to vibrate, resonate, or otherwise physically move to modulate the phase, amplitude, and/or propagation direction of the coherent light arriving at and reflecting/scattering off of the pixel. The AC waveform may be any type of waveform, such as sinusoidal, saw tooth, square wave, or a combination of multiple waveforms, and/or waveforms of multiple frequencies.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a system diagram of a laser projection system utilizing a light modulation device in accordance with an embodiment of the present invention;

FIG. 2 is perspective view of a light modulator in accordance with an embodiment of the present invention;

FIG. 3 is an exploded view of an exemplary pixel of a light modulator that may be used in accordance with an embodiment of the present invention;

FIGS. 4a and 4b are side views of a pixel illustrating various movements that may be induced in accordance with an embodiment of the present invention;

FIGS. 5a-5c are waveforms that may be used in accordance with an embodiment of the present invention; and

FIG. 6 a graph illustrating amplitudes of displacement of a mirror ensemble that may be obtained for a given AC frequency in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

It should be noted that embodiments of the present invention are discussed in terms of a laser projection system for illustrative purposes only and that embodiments of the present invention may be utilized in any type of system, particularly systems using a monochromatic coherent light source, in which speckle may be a problem. Examples of systems in which embodiments of the present invention may be useful include projection systems, illumination systems, diagnostic systems, other systems using laser light, and the like.

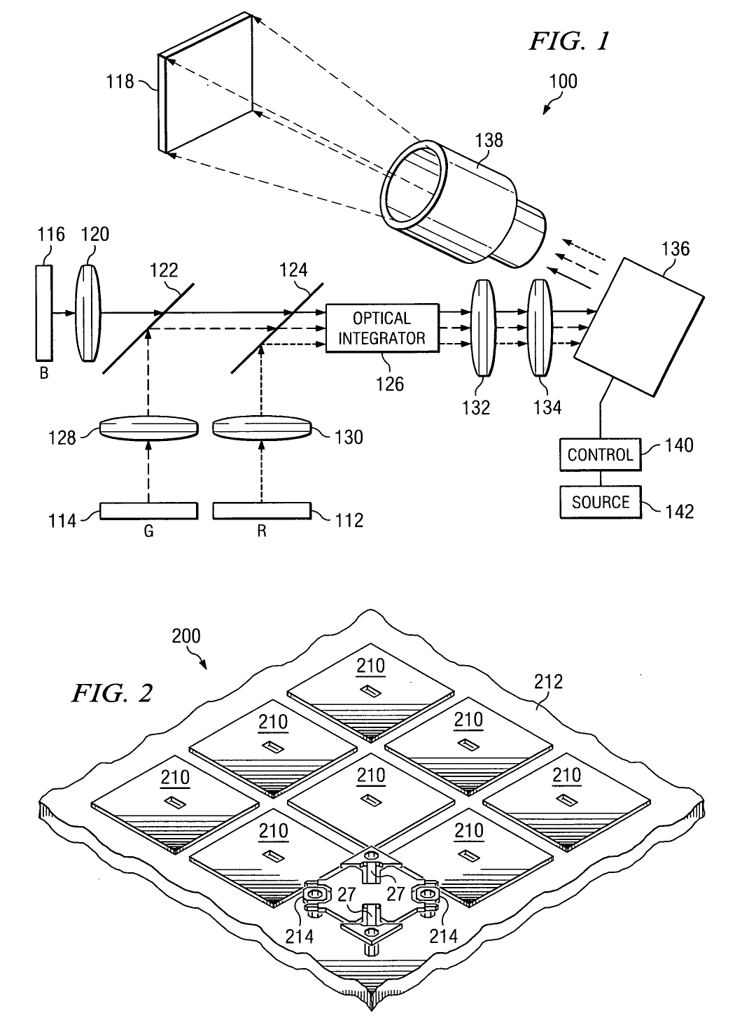

FIG. 1 is a configuration diagram illustrating selected components of a projection display system 100 in accordance with an embodiment of the present invention. The projection display system 100 includes various components that define an optical path between coherent light sources 112, 114, and 116 and display screen 118. Coherent light sources 112, 114, and 116 may be, for example, a red laser, a green laser, and a blue laser, respectively. The light can be applied sequentially by turning on and off each of the red, green, and blue lasers, or by turning on and off any combination of lasers.

In operation, light from a blue coherent light source 116 is transmitted via lens 120 through filter 122 and filter 124 to optical integrator 126. Likewise, light from a green coherent light source 114 passes through lens 128 and then is reflected from filter 122 and transmitted through filter 124 to optical integrator 126. Light from a red coherent light source 112 passes through lens 130 and is then reflected from filter 124 to optical integrator 126. Light from optical integrator 126 is transmitted to (and through) relay lenses 132 and 134, from there it is directed to a light modulator 136. The light modulator 136 selectively directs light to a projection lens 138 and on to the display screen or other display medium 118. The light modulator 136 may be, for example, a DMD chip manufactured by Texas Instruments, Inc., of Dallas, Tex. The operation data is provided by a timing and control circuit 140 as determined from signal processing circuitry according to an image source 142.

It should be noted that other components may be used. For example, other embodiments of the present invention may utilize other DMD arrays or even other types of light modulators. Furthermore, other types of illumination geometries, such as edge or corner geometries, can also be used. In embodiments of the present invention, DMDs manufactured with mirror pitch of 17, 13.7 and 10.8 micrometers and +/−10 to +/−14 degree mirror tilt are used. This invention can be used with other mirror sizes and/or tilt angles

It should be noted that the projection display system 100 is provided for illustrative purposes only and that the projection display system 100 may include other components not shown in FIG. 1. For example, the projection display system 100 may include power supplies, light sinks, fewer or additional light sources, and the like.

FIG. 2 illustrates an example of a portion of a DMD chip 200 that may be used as the light modulator 136 (see FIG. 1) in accordance with an embodiment of the present invention. The DMD chip 200 includes an array of mirror elements 210 suspended over a substrate 212, each mirror element 210 being separately controllable. Electrostatic attraction between the mirror elements 210 and address electrodes 214 causes the mirror to twist or pivot, in either of two directions, about an axis formed by a pair of torsion beam hinges 27. The tilt of the mirror is, for example, on the order of plus 10-12 degrees (on) or minus 10-12 degrees (off) to modulate the light that is incident on the surface.

The DMD chip 200 is typically controlled by electronic circuitry (not shown) that has been fabricated on the silicon substrate 212 and is generally disposed under the mirror elements 210. The circuitry includes an array of memory cells (not shown), typically one memory cell for each mirror element 210, connected to the address electrodes 214. The output of a memory cell is connected to one of the two address electrodes 214 and the inverted output of a memory cell is connected to the other address electrode.

Once data is written to each memory cell in the array, a voltage is applied to the individual mirror elements 210 creating a large enough voltage differential between the mirror elements 210 and the address electrodes 214 to cause the mirror to rotate or tilt in the direction of the greatest voltage potential. Because the electrostatic attraction grows stronger as the mirror is rotated near an address electrode, the memory cell contents may be changed without altering the position of the mirrors once the mirrors are fully rotated. Thus, the memory cells may be loaded with new data while the array is displaying previous data.

As should be apparent, the rotation of the individual mirror elements 210 determines the amount and quality of light that will be directed at projection lens 138. The light reflected from any of the mirror elements 210 may pass through a projection lens 138 in order to create images on the screen 118. The intensity of each color displayed on the screen 118 is determined by the amount of time the mirror elements 210, corresponding to a particular pixel, direct light toward screen 118. For example, each pixel may have 256 intensity levels for each color (e.g., red, green, or blue). If the color level selected for a particular pixel at a particular time is 128, then the corresponding mirror would direct light toward that area of screen 118 for ½ (e.g., 128/256) of the frame time.

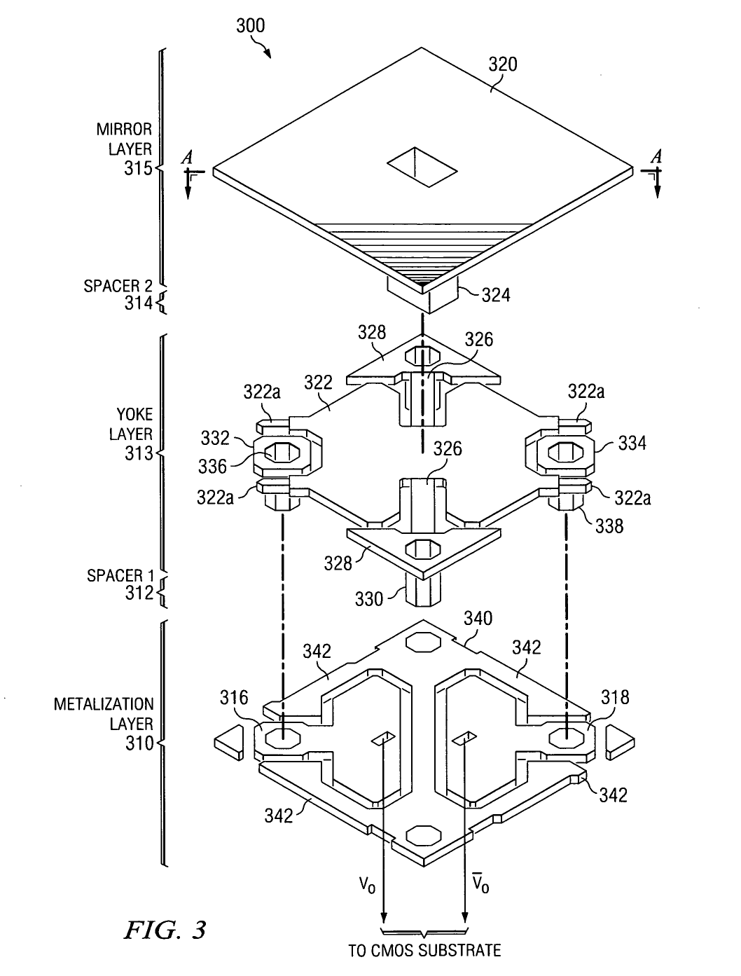

FIG. 3 is an exploded view of a single pixel 300 of a DMD chip, such as the DMD chip 200 illustrated in FIG. 2, in accordance with an embodiment of the present invention. An underlying CMOS substrate having memory and control circuitry is not shown. The pixel 300 can be thought of as having five layers fabricated over the CMOS substrate. Beginning at the bottom, these layers are a metallization layer 310, a first spacer layer 312, a yoke layer 313, a second spacer layer 314, and a mirror layer 315.

In the example of this description, the overall dimensions of pixel 300 are approximately 16 microns in area and 3 microns in height. The pixels 300 of the DMD chip 200 are on approximately 17 micron centers. Various dimensions are given herein consistent with this example pixel for illustrative purposes only and to provide relative proportions of various structural elements in an embodiment. However, it should be understood that pixels could be fabricated in a range of other sizes and tilt angle in other embodiments of the present invention.

For each pixel 300, the data of an associated memory cell (not shown) is provided to a pair of complementary address electrode lines (not shown), each line in turn being connected to one of two address electrodes 316 and 318. Pixel 300 has a square mirror 320 supported upon and elevated above a yoke 322 by a support post 324. Support post 324 extends downward from the center of mirror 320, and is attached to the center of yoke 322. Yoke 322 has a generally butterfly shape and is axially supported along a center axis by a pair of torsion hinges 326. One end of each torsion hinge 326 is attached to and supported by a hinge support cap 328 on top of a hinge support post 330. A pair of elevated address electrodes 332 and 334 is supported by address electrode support posts 336 and 338.

The address support posts 336 and 338 and the hinge support posts 330 support the elevated mirror address electrodes 332 and 334, the torsion hinges 326, and yoke 322 away from and above a bias/reset bus 340 and address electrodes 316 and 318. When mirror 320 and yoke 322 are rotated about the torsion axis of the yoke 322, a pair of spring-tips 322a, which protrude from the leading edge of the yoke 322 that is deflected, land upon the bias/reset bus 340 at landing sites 342. The “leading edge” of yoke 322 is the portion of yoke 322 that comes closest to the metallization layer when mirror 320 is tilted and spring-tips 322a are landed.

The pixel 300 of FIG. 3 and of the following description has its addressing circuitry on two levels. Some of the addressing circuitry is fabricated on the metallization layer, such as electrodes 316 and 318. Other portions of the addressing circuitry are fabricated as part of the yoke layer, such as the elevated address electrodes 332 and 334. The pixel 300 is described in greater detail in U.S. Pat. No. 6,819,470, which is incorporated herein by reference. One of ordinary skill in the art will realize that other pixel configurations may be used in other embodiments of the present invention.

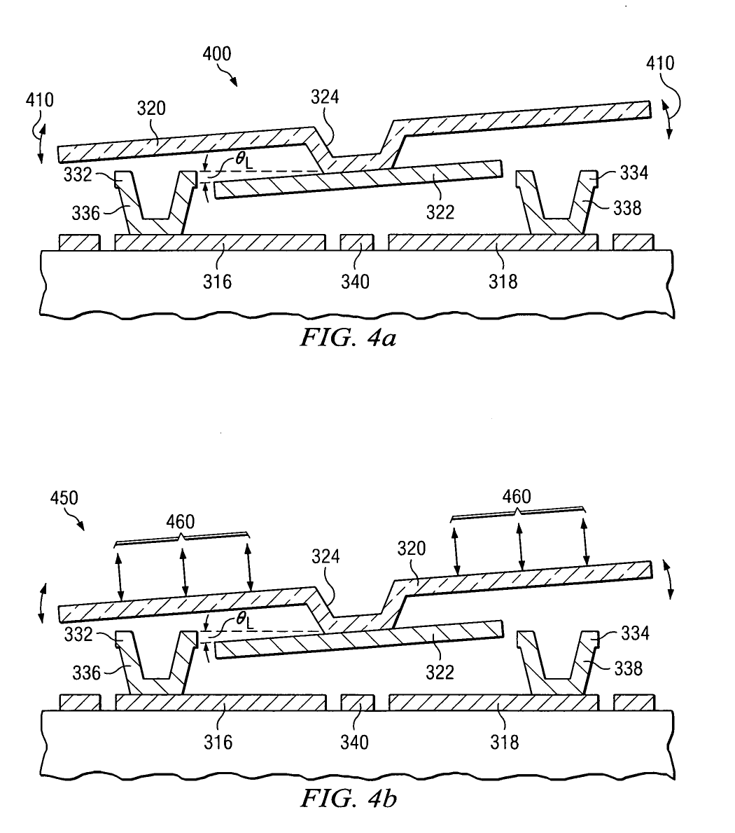

FIGS. 4a-4b illustrate two embodiments of the present invention in which the coherent light emitted by coherent light sources 112, 114, and 116 (see FIG. 1) is phase and/or amplitude modulated in accordance with embodiments of the present invention. The sideview of the pixel illustrated in FIGS. 4a-4b are sideviews of the pixel 300 illustrated in FIG. 3, wherein the sideview is taken along the A-A line illustrated in FIG. 3. Generally, embodiments of the present invention phase, amplitude, and/or direction modulate the coherent light source by imparting motion in one or more of the components of light modulator 136 (FIG. 1). The motion may be induced, for example, by using a bias voltage having a DC component and an AC component, as will be described in greater detail below.

Referring first to FIG. 4a, a cross section view of pixel 300 illustrated in FIG. 3 that has been rotated θ_{L} degrees to the “on” position (i.e., light is being projected toward the display screen 118 of FIG. 1) with a “wobbling” motion in accordance with an embodiment of the present invention is shown, wherein like reference numerals refer to like elements. In an embodiment θ_{L} is about 10°. Also shown are address electrodes 332 and 334.

As indicated by arrows 410, an embodiment of the present invention causes mirror element 320 to “wobble” or rotate back and forth. It has been found that controlling the mirror element 320 in this manner induces a phase, amplitude, and/or direction modulation in the coherent light source. By inducing a phase, amplitude and/or direction modulation in the coherent light source, the laser speckle may be reduced and/or eliminated. In an embodiment the amount of wobble is about ±0.01-1 degrees.

Referring now to FIG. 4b, another motion is illustrated in accordance with an embodiment of the present invention. The pixel of FIG. 4b is similar to the pixel 400 of FIG. 4a, wherein like reference numerals refer to like elements. The pixel 450 is rotated θ_{L} degrees to the “on” position, but has a pulsing or vibrating motion as indicated by arrows 460 in accordance with an embodiment of the present invention. As indicated by arrows 460, an embodiment of the present invention causes mirror element 320 to pulse or vibrate the mirror element substantially along an axis normal to the major surface of the mirror element. It has been found that controlling the mirror element 320 in this manner may also induce a phase, amplitude and or direction modulation in the coherent light source. By inducing a phase, amplitude and/or direction modulation in the coherent light source the laser speckle may be reduced and/or eliminated. In an embodiment the amount of vibration is about ±0.1-100 microns.

The motions illustrated in FIGS. 4a and 4b may be achieved by using a bias differential having a DC component and an AC component. In particular, the wobbling motion illustrated in FIG. 4a may be achieved by altering the attractive forces between the mirror element 320 and the address electrodes 336 and 338 while the mirror element is in the “on” state. Altering the attractive forces will determine how far the mirror elements will be drawn toward the address electrodes. Effectively, this motion is achieved by altering the net torque being applied to the hinge 326 (see FIG. 3). One skilled in the art will appreciate that this motion will cause the angle of reflection, the phase and the amplitude to change slightly. However, the amplitude of the AC component may be adjusted to be small enough without significantly affecting the output image but yet impart a phase, amplitude, and/or direction, modulation on the coherent light.

A motion such as that described above with reference to FIG. 4b may be caused by applying an AC component having a frequency and an amplitude in accordance with a resonant frequency of one or more of the components of the pixel. In this manner, one or more of the components of the pixel may be caused to resonate or vibrate. In this example, the AC component causes the hinge 326 (see FIG. 3), and thus the mirror element 320, to resonate or vibrate. By applying various AC components to the DC component and other types of movement or combinations of movements may be caused.

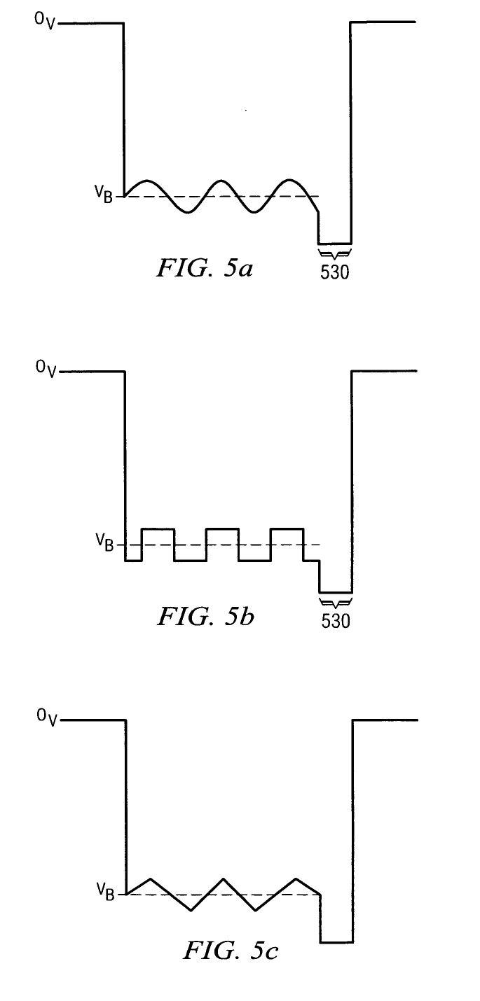

FIG. 5a illustrates a simplified wave form that may be used to control the DMD chip in accordance with an embodiment of the present invention. As discussed above, an embodiment of the present invention utilizes a differential bias V_{B} having a DC component and an AC component. The DC component primarily acts to cause the mirror element 320 to rotate towards the address electrodes 332 and 334. The AC component is applied to impart a physical motion to one or more elements of the pixels by varying the amount of net torque applied to the hinge 326 (causing a motion such as that illustrated in FIG. 4a), by causing one or more components of the pixel to resonant (causing a motion such as that illustrated in FIG. 4b), and/or the like.

Generally, the address electrode 332 (see FIGS. 3, 4a, and 4b) is set to a potential and a differential bias V_{B} is applied to the mirror element 320 (see FIGS. 3, 4a, and 4b), thereby creating a net torque to rotate the mirror element 320 towards address electrode 332. U.S. Pat. No. 5,096,279, which is incorporated herein by reference, discloses the addressing and biasing scheme of a typical bi-stable DMD in greater detail.

In an embodiment, the differential bias V_{B} is about 15-35 VDC, and the AC component is a sinusoidal wave form having an amplitude of about 0.01% to about 100% of the differential bias V_{B}. Also shown in FIG. 5 is a reset period 530. Generally, the reset period 530 comprises a short duration of an increased differential bias V_{B} to induce a springing action to cause the mirror element 320 to be released from the address electrodes 332 and 334. One of ordinary skill in the art will realize that other waveforms may be used with other embodiments of the present invention and that a particular waveform may be derived to better suit a particular application. Furthermore, it should be noted that the AC component is illustrated as having a sinusoidal waveform for illustrative purposes only and that other waveforms may be used, such as square or triangular waveforms illustrated in FIGS. 5b and 5c, respectively.

The particular waveform that is to be used is dependent on, among other things, the construction of the pixels, the materials used to construct the various components of the pixels, the size of the components, the shape of the components, characteristics of the coherent light source, the desired motion, and the like. Furthermore, the AC component is dependent upon the component of the pixel upon which motion is desired. For example, different AC components may be used to impart motion on, among others, the mirror element, one or more of the support posts, the spring-tips, the yoke, the hinge, the address electrodes, hinge support caps, or the like.

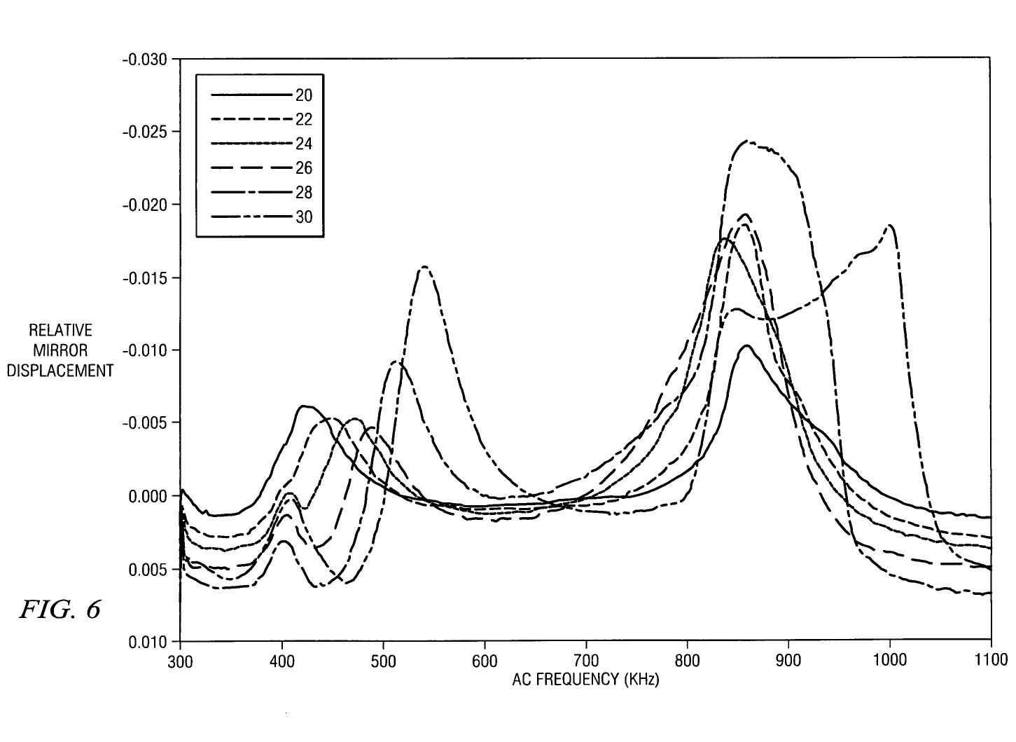

FIG. 6 is a graph illustrating amplitudes of displacement of a mirror ensemble that may be obtained for a given AC frequency in accordance with an embodiment of the present invention. In particular, FIG. 6 illustrates a series of curves corresponding to the relative average amplitude of displacement of an ensemble of mirrors versus applied AC frequency for varying DC voltages. The family of curves shown in the figure results from applying a 20-30 VDC bias (as indicated by the legend) additively to the AC bias indicated along the horizontal axis. Other voltages and frequencies, AC and DC, may be used.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A projection system comprising:
a coherent light source configured to emit a beam of coherent light;
a light modulator positioned to intercept the beam of coherent light, the light modulator comprising a plurality of pixels, each pixel having one or more pixel components having a resonant frequency; and
a controller configured to cause a bias voltage to be applied to the plurality of pixels, the bias voltage having a DC component and an AC component, the AC component causing one or more of the pixel components to move.

2. The projection system of claim 1, wherein the AC component has a frequency substantially equivalent to the resonant frequency of one or more of the pixel components.

3. The projection system of claim 1, wherein the AC component is about 0.01% to about 100% of the DC component.

4. The projection system of claim 1, wherein the DC component is about 15 V to about 35 V.

5. The projection system of claim 1, wherein the light modulator comprises a digital micromirror device (DMD).

6. The projection system of claim 5, wherein the AC component has a frequency approximately equivalent to the resonant frequency of a hinge supporting a mirror element.

7. The projection system of claim 5, wherein the AC component has a frequency approximately equivalent to the resonant frequency of a post supporting a mirror element.

8. A method of controlling a projection system, the method comprising:
directing coherent light toward a light modulator, the light modulator comprising in plurality of pixels, each of the pixels comprising one or more pixel components having a resonant frequency; and
applying a bias voltage having a DC component and an AC component, the AC component having a frequency sufficient to cause one or more of the pixel components to resonate.

9. The method of claim 8, wherein the AC component is about 0.01% to about 100% of the DC component.

10. The method of claim 8, wherein the light modulator comprises a digital micromirror device (DMD).

11. The method of claim 10, wherein the AC component has a frequency approximately equivalent to the resonant frequency of a hinge supporting a mirror element.

12. The method of claim 10, wherein the AC component has a frequency approximately equivalent to the resonant frequency of a post supporting a mirror element.

13. A method of reducing speckle in the projection display system that utilizes a coherent light source, the method comprising:
positioning a reflective element to direct light from the coherent light source toward a display surface; and
moving the reflective element relative to the coherent light source while the reflective element is reflecting light from the coherent light source toward the display surface, thereby modulating the coherent light reflected by the reflective element.

14. The method of claim 13, wherein the moving comprises applying a DC component and an AC component.

15. The method of claim 14, wherein the AC component has a frequency and amplitude sufficient to cause one or more components of the reflective element to resonate.

16. The method of claim 14, wherein the AC component has a frequency and amplitude sufficient to cause one or more elements of the reflective element to wobble.

17. The method of claim 14, wherein the AC component is about 0.01% to about 100% of the DC component.

18. The method of claim 14, wherein the reflective element comprises a digital micromirror device (DMD).

19. The method of claim 18, wherein the AC component has a frequency approximately equivalent to the resonant frequency of a hinge supporting a mirror element.

20. The method of claim 18, wherein the AC component has a frequency approximately equivalent to the resonant frequency of a post supporting a mirror element.
